(19) United States
(12) Patent Application Publication
(10) Pub. No.: US 2013/0045693 A1
(43) Pub. Date: Feb. 21, 2013

(54) METHOD AND APPARATUS FOR TRIGGERING MEASUREMENT REPORTING BASED UPON NEIGHBOR CELL INTERFERENCE

(71) Applicants: Tao Chen, Salo (FI); Keiichi Kubota, Weybridge (GB); Brian Martin, Farnham (GB)

(72) Inventors: Tao Chen, Salo (FI); Keiichi Kubota, Weybridge (GB); Brian Martin, Farnham (GB)

(73) Assignee: RENESAS MOBILE CORPORATION, Tokyo (JP)

(21) Appl. No.: 13/209,945

(22) Filed: Aug. 15, 2011

(51) Int. Cl. H04W 24/00

(52) U.S. Cl. 455/67.13

(57) ABSTRACT

A method, apparatus and computer program product are provided for triggering a measurement report from a mobile terminal, such as a mobile terminal is in the CELL_FACH state, to a network entity in an instance in which the mobile terminal may be creating neighbor cell interference. Based upon the measurement report, the serving cell may modify the operation of the mobile terminal in order to reduce the potential for neighbor cell interference. In this regard, a method is provided that includes determining two or more parameters indicative of neighbor cell interference. In instance in which the parameters satisfy respective thresholds, the method also causes a measurement report including an indication of at least one of the parameters to be provided to a network element.

### TECHNOLOGICAL FIELD

Embodiments of the present invention relate generally to communications technology and, more particularly, to measurement reporting that is triggered based upon potential neighbor cell interference.

### BACKGROUND

The communications between a mobile terminal and a serving cell, such as the uplink communications from the mobile terminal to the serving cell, may sometimes create interference with neighbor cells. This interference may inhibit the operation of the neighbor cells or may at least cause the mobile terminal and/or the neighbor cells to operate less efficiently. In some operational states, such as a CELL_DCH state, the mobile terminal and the serving cell may monitor the neighbor cells in such a manner that instances of neighbor cell interference may be identified and the operation of the mobile terminal and/or the serving cell may be modified in such a manner as to reduce the potential for the neighbor cell interference. Indeed, in the CELL_DCH state, the neighbor cells may be added to the active set so as to be involved in uplink power control. In this regard, the mobile terminal may receive signals from the serving cell as well as the neighbor cells. As such, neighbor cells may identify instances in which the mobile terminal is creating interference such that the mobile terminal may reduce its uplink power in an effort to correspondingly reduce the neighbor cell interference. More particularly, for a mobile terminal operating in a CELL_DCH state, the uplink power from the mobile terminal may be controlled via relative grants from neighbor cells within the active set of the mobile terminal.

In other operational states, however, the mobile terminal may not communicate with the neighbor cells in the same manner and, as such, may not be able to identify instances of potential neighbor cell interference. For example, a mobile terminal in a CELL_FACH state may only receive signals from the serving cell. As such, in instances in which the mobile terminal is creating interference for the neighbor cells, the neighbor cells are unable to communicate with the mobile terminal in order to request that the power, such as the uplink power, be reduced in an effort to correspondingly reduce the neighbor cell interference. For example, in contrast to the relative grants from neighbor cells to a mobile terminal in a CELL_DCH state that serve to control the uplink power, a mobile terminal operating in the CELL_FACH state may not have similar control of its uplink power since the uplink power of the mobile terminal may only be controlled by the serving cell using absolute grants without consideration of possible neighbor cell interference. As such, a mobile terminal that is creating neighbor cell interference may impair the operation of the neighbor cells and, in some instances, may suffer from radio link failure.

In Release 8 of the Third Generation Partnership Project (3GPP) specification, an enhanced uplink for a mobile terminal in the CELL_FACH state in the idle mode was introduced. This enhanced uplink is termed a common enhanced dedicated channel (Common E-DCH). As such, mobile terminals may utilize the E-DCH in other radio resource control (RRC) states in addition to or other than the CELL_DCH state. Notwithstanding the potential for the creation of neighbor cell interference to be created by the uplink transmissions of a mobile terminal in the CELL_FACH state, it is anticipated that mobile terminals will frequently operate in the CELL_FACH state, such as to perform infrequent or bursty data transmissions, and that operation of mobile terminals in the CELL_FACH state may increase as a result of the introduction of the E-DCH. As such, the issues relating to potential neighbor cell interference while a mobile terminal is operating in the CELL_FACH state may also become more frequent and problematic.

A number of signaling based methods have been proposed in an effort to provide some measure of interference control for the neighbor cells in instances in which a mobile terminal is operating in the CELL_FACH state. However the proposals have generally suffered from various drawbacks including, for example, increased complexity for the mobile terminal and/or the serving cell or the failure to address all use cases or scenarios.

### BRIEF SUMMARY

A method, apparatus and computer program product are therefore provided according to an example embodiment in order to trigger a measurement report from the mobile terminal to a serving cell in an instance in which the mobile terminal may be creating neighbor cell interference. Based upon the measurement report, the serving cell may modify the operation of the mobile terminal in order to reduce the potential for neighbor cell interference. In one embodiment, the method, apparatus and computer program product may provide measurement reporting in an instance in which neighbor cell interference has been potentially created while the mobile terminal is in the CELL_FACH state. As such, the method, apparatus and computer program product of example embodiments of the present invention may reduce neighbor cell interference, thereby improving overall system performance.

In one embodiment, a method is provided that includes determining two or more parameters indicative of neighbor cell interference and selected from a group consisting of transmission power for signals transmitted via an uplink channel, a neighbor cell path loss for signals received from a neighbor cell, an uplink interference level, a serving cell path loss and a difference between the transmission power and the serving cell path loss. In instance in which the two or more parameters satisfy respective thresholds, the method also causes a measurement report including an indication of at least one of the parameters to be provided to a network element.

In another embodiment, an apparatus is provided that includes at least one processor and at least one memory including computer program code with the at least one memory and the computer program code configured to, with the at least one processor, cause the apparatus at least to determine two or more parameters indicative of neighbor cell interference and selected from a group consisting of transmission power for signals transmitted via an uplink channel, a neighbor cell path loss for signals received from a neighbor cell, an uplink interference level, a serving cell path loss and a difference between the transmission power and the serving cell path loss. The at least one memory and the computer program code are also configured to, with the at least one processor, cause the apparatus of this embodiment to provide a measurement report to a network element in instance in which the two or more parameters satisfy respective thresholds. The measurement report may include an indication of at least one of the parameters.

In a further embodiment, a computer program product is provided that includes at least one non-transitory computer-readable storage medium having computer-readable program instructions stored therein with the computer-readable program instructions including program instructions configured to determine two or more parameters indicative of neighbor cell interference and selected from a group consisting of transmission power for signals transmitted via an uplink channel, a neighbor cell path loss for signals received from a neighbor cell, an uplink interference level, a serving cell path loss and a difference between the transmission power and the serving cell path loss. The computer-readable program instructions of this embodiment also include program instructions configured to provide a measurement report to a network element in instance in which the two or more parameters satisfy respective thresholds. The measurement report may include an indication of at least one of the parameters.

In yet another embodiment, an apparatus is provided that includes means for determining two or more parameters indicative of neighbor cell interference and selected from a group consisting of transmission power for signals transmitted via an uplink channel, a neighbor cell path loss for signals received from a neighbor cell, an uplink interference level, a serving cell path loss and a difference between the transmission power and the serving cell path loss. The apparatus of this embodiment also includes means for providing a measurement report to a network element in instance in which the two or more parameters satisfy respective thresholds. The measurement report may include an indication of at least one of the parameters.

In one embodiment, a method is provided that includes determining whether neighbor cell interference is being caused while a mobile terminal is in a CELL_FACH state. The method of this embodiment also causes a measurement report to be provided to a network element in instance in which neighbor cell interference is being caused.

In another embodiment, an apparatus is provided that includes at least one processor and at least one memory including computer program code with the at least one memory and the computer program code configured to, with the at least one processor, cause the apparatus at least to determine whether neighbor cell interference is being caused while a mobile terminal is in a CELL_FACH state. The at least one memory and the computer program code are also configured to, with the at least one processor, cause the apparatus of this embodiment to cause a measurement report to be provided to a network element in instance in which neighbor cell interference is being caused.

In a further embodiment, a computer program product is provided that includes at least one non-transitory computer-readable storage medium having computer-readable program instructions stored therein with the computer-readable program instructions including program instructions configured to determine whether neighbor cell interference is being caused while a mobile terminal is in a CELL_FACH state. The computer-readable program instructions of this embodiment also include program instructions configured to cause a measurement report to be provided to a network element in instance in which neighbor cell interference is being caused.

In yet another embodiment, an apparatus is provided that includes means for determining whether neighbor cell interference is being caused while a mobile terminal is in a CELL_FACH state. The apparatus of this embodiment also includes means for causing a measurement report to be provided to a network element in instance in which neighbor cell interference is being caused.

### BRIEF DESCRIPTION OF THE DRAWINGS

Having thus described the example embodiments of the invention in general terms, reference will now be made to the accompanying drawings, which are not necessarily drawn to scale, and wherein:

FIG. 1 is a schematic representation of a system having a serving cell and one or more neighbor cells that may experience interference created by the mobile terminal and that may benefit from an embodiment of the present invention;

FIG. 2 is a block diagram of an apparatus that may be embodied by a mobile terminal in accordance with one embodiment of the present invention;

FIG. 3 is a flow chart illustrating operations performed in accordance with one embodiment of the present invention; and

FIG. 4 illustrates the flow chart of operations performed in accordance with another embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term ‘circuitry’ refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

A method, apparatus and computer program product of an example embodiment of the present invention are configured to determine instances in which a mobile terminal may be creating neighbor cell interference, such as a result of interference created by uplink transmissions from the mobile terminal to a serving cell. In accordance with an example embodiment, a measurement report may be triggered by the determination that the mobile terminal may be creating neighbor cell interference. Based upon the measurement report, the serving cell may determine if any modification of the operation of the mobile terminal is desired in order to reduce the neighbor cell interference. In one embodiment, the mobile terminal identifies the potential for neighbor cell interference while in the CELL_FACH state, thereby permitting neighbor cell interference to be reduced or otherwise addressed even while the mobile terminal is in the CELL_FACH state.

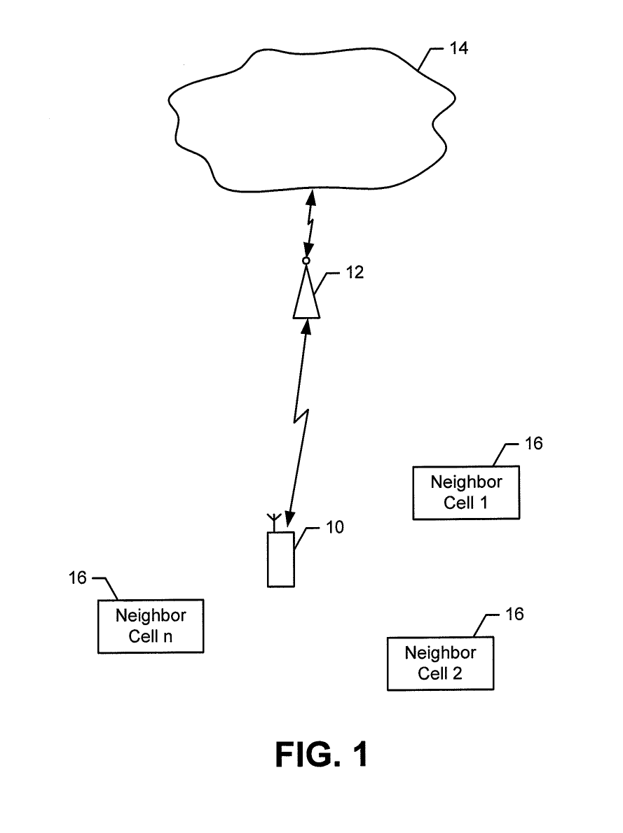

Although the method, apparatus and computer program product may be implemented in a variety of different systems, one example of such a system is shown in FIG. 1, which includes a first communication device (e.g., mobile terminal 10) that is capable of communication via a serving cell 12, such as a base station, a Node B, an evolved Node B (eNB) or other access point, with a network 14 (e.g., a core network). While the network may be configured in accordance with Long Term Evolution (LTE) or LTE-Advanced (LTE-A), other networks may support the method, apparatus and computer program product of embodiments of the present invention including those configured in accordance with wideband code division multiple access (W-CDMA), CDMA2000, global system for mobile communications (GSM), general packet radio service (GPRS) and/or the like.

The network 14 may include a collection of various different nodes, devices or functions that may be in communication with each other via corresponding wired and/or wireless interfaces. For example, the network may include one or more cells, including serving cell 12 and one or more neighbor cells 16 (designated neighbor cell 1, neighbor cell 2, . . . neighbor cell n in the embodiment of FIG. 1), each of which may serve a respective coverage area. The serving cell and the neighbor cells could be, for example, part of one or more cellular or mobile networks or public land mobile networks (PLMNs). In turn, other devices such as processing devices (e.g., personal computers, server computers or the like) may be coupled to the mobile terminal 10 and/or other communication devices via the network.

A communication device, such as the mobile terminal 10 (also known as user equipment (UE)), may be in communication with other communication devices or other devices via the serving cell 12 and, in turn, the network 14. In some cases, the communication device may include an antenna for transmitting signals to and for receiving signals from a serving cell.

In some example embodiments, the mobile terminal 10 may be a mobile communication device such as, for example, a mobile telephone, portable digital assistant (PDA), pager, laptop computer, or any of numerous other hand held or portable communication devices, computation devices, content generation devices, content consumption devices, or combinations thereof. As such, the mobile terminal 10 may include one or more processors that may define processing circuitry either alone or in combination with one or more memories. The processing circuitry may utilize instructions stored in the memory to cause the mobile terminal 10 to operate in a particular way or execute specific functionality when the instructions are executed by the one or more processors. The mobile terminal 10 may also include communication circuitry and corresponding hardware/software to enable communication with other devices and/or the network 14.

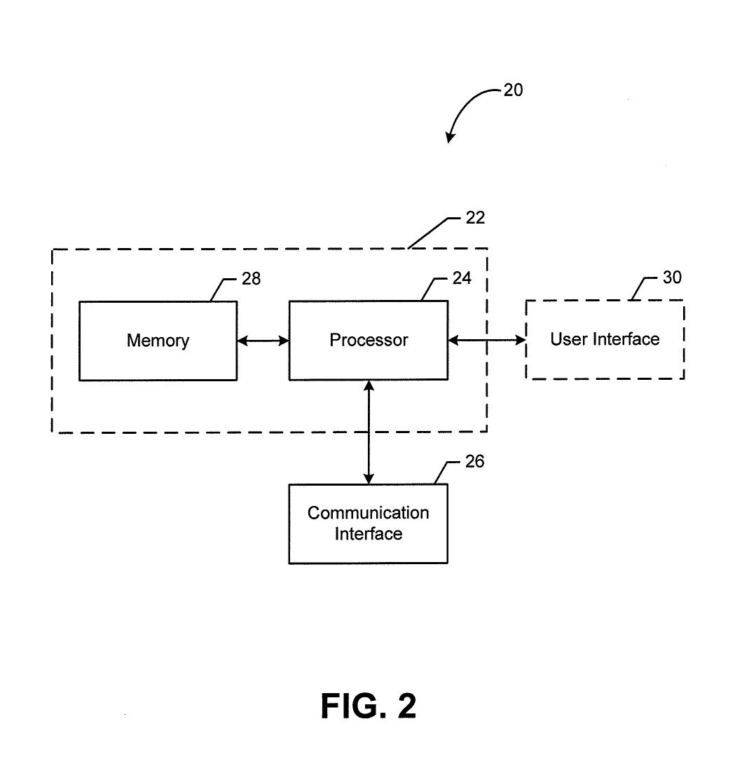

In one embodiment, for example, the mobile terminal 10 and/or the serving cell 12 may be embodied as or otherwise include an apparatus 20 as generically represented by the block diagram of FIG. 2. While the apparatus 20 may be employed, for example, by a mobile terminal 10 or a serving cell 12, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 28 that may be in communication with or otherwise control a communication interface 26 and, in some cases, a user interface 30. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 10, the processing circuitry may be embodied as a portion of a mobile computing device or other mobile terminal.

The user interface 30 (if implemented) may be in communication with the processing circuitry 22 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms. The apparatus 20 need not always include a user interface. For example, in instances in which the apparatus is embodied as a serving cell 12, the apparatus may not include a user interface. As such, the user interface is shown in dashed lines in FIG. 2.

The communication interface 26 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network 14 and/or any other device or module in communication with the processing circuitry 22, such as between the mobile terminal 10 and the serving cell 12. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 28 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 28 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

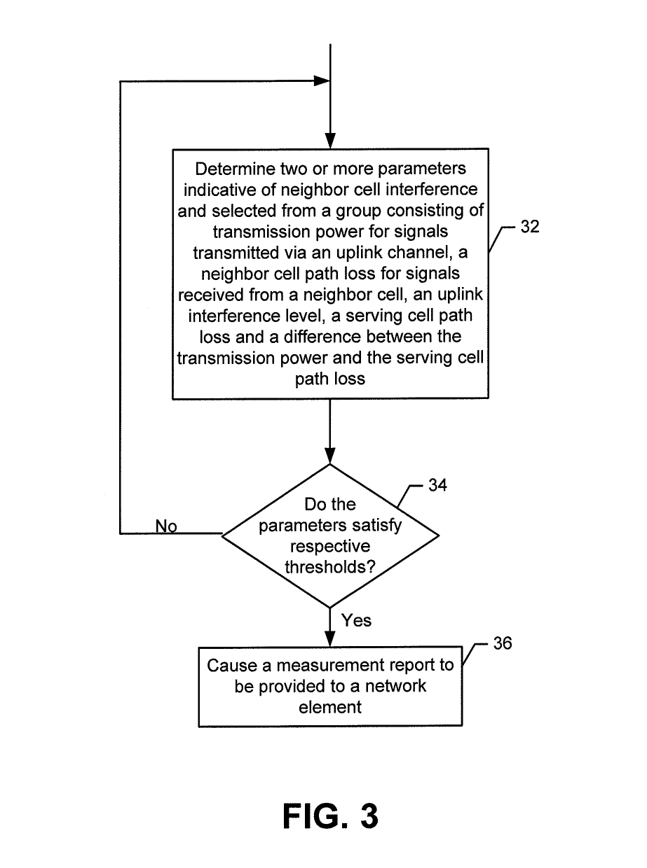

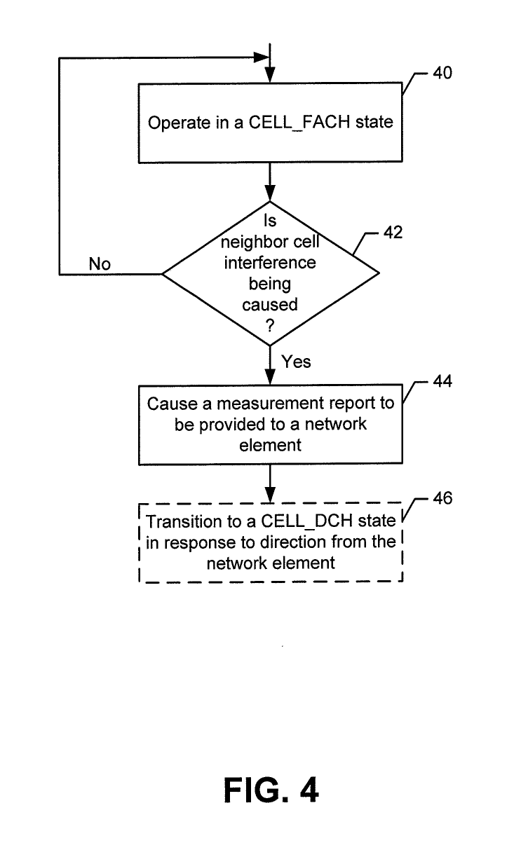

Referring now to FIGS. 3 and 4, flowcharts illustrating the operations performed by a method, apparatus and computer program product, such as apparatus 20 of FIG. 2, from the perspective of a mobile terminal 10 in accordance with one embodiment of the present invention are illustrated. It will be understood that each block of the flowcharts, and combinations of blocks in the flowcharts, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device 28 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowcharts' block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowcharts' block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). As such, the operations of FIGS. 3 and 4, when executed, convert a computer or processing circuitry into a particular machine configured to perform an example embodiment of the present invention. Accordingly, the operations of each of FIGS. 3 and 4 define an algorithm for configuring a computer or processing circuitry 22, e.g., processor, to perform an example embodiment. In some cases, a general purpose computer may be provided with an instance of the processor which performs the algorithm of a respective one of FIGS. 3 and 4 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified as described below. Moreover, in some embodiments additional optional operations may also be included (an example of which is shown in dashed lines in FIG. 4). It should be appreciated that each of the modifications, optional additions or amplifications below may be included with the operations above either alone or in combination with any others among the features described herein.

Referring now to FIG. 3, the operations of a method, apparatus and computer program product o provide a measurement report from a mobile terminal 10 to a serving cell 12 or other network element in an instance in which the mobile terminal may be creating neighbor cell interference is illustrated. As shown in operation 32, the apparatus 20 may include means, such as the processing circuitry 22, the processor 24 or the like, for determining two or more parameters that may be indicative of neighbor cell interference. While several parameters are described below for purposes of illustration, additional or different parameters may be determined in other embodiments. For example, the apparatus may include means, such as the processing circuitry, the processor or the like, for determining the transmission power for signals transmitted by the mobile terminal via an uplink channel. In one embodiment, the apparatus, such as the processor, may determine the transmission power of the signals transmitted via the uplink dedicated physical control channel (DPCCH) to the serving cell. In an instance in which the transmission power for signals transmitted via an uplink channel, such as the uplink DPCCH, is relatively high, the mobile terminal may be located relatively far from the serving cell and/or the mobile terminal may be suffering from uplink interference from other mobile terminals served by the neighbor cells 16. In either instance, a relatively high transmission power for signals transmitted via an uplink channel of the mobile terminal may create interference with the neighbor cells.

Additionally or alternatively, the apparatus 20 may also include means, such as the processing circuitry 22, the processor 24 or the like, for determining the neighbor cell path loss for signals received by the mobile terminal 10 from a neighbor cell 16. In one embodiment, the neighbor cell path loss may be determined to be the difference between the value of the primary common pilot channel (CPICH) transmission power as signaled by the network and the CPICH received signal code power (RSCP) as measured by the mobile terminal. The path loss of a neighbor cell provides an indication as to the distance between the mobile terminal and the neighbor cell. In an instance in which the path loss is relatively small, the mobile terminal may be relatively near the neighbor cell, thereby increasing the likelihood that the signal transmissions by the mobile terminal may create interference for the neighbor cell. Conversely, in an instance in which the path loss is relatively large, the mobile terminal may be relatively far away from the neighbor cell such that there is a lower likelihood that the signal transmissions from the mobile terminal will create interference for the neighbor cell.

The apparatus 20 may also include means, such as the processing circuitry 22, the processor 24 or the like, for determining other parameters or conditions associated with the operation of the mobile terminal 10 that may be indicative of neighbor cell interference. For example, the apparatus may include means, such as the processing circuitry, the processor or the like, for determining an uplink interference level at a neighbor cell 16. For example, the apparatus, such as the processor, the communication interface 26 or the like, may receive information provided by the neighbor cell, such as via a system information block (SIB), e.g., SIB7, so as to obtain information regarding the uplink interference level of the neighbor cell. Additionally or alternatively, the apparatus may include means, such as the processing circuitry, the processor or the like, for determining the serving cell path loss, that is, the path loss between the mobile terminal and the serving cell 12 and/or a difference between the transmission power and the serving cell path loss, thereby providing an indication of the power received by the serving cell from the mobile terminal.

Based upon at least two of the foregoing parameters, such as the transmission power, the neighbor cell path loss, the uplink interference level, the serving cell path loss and/or the difference between the transmission power and the serving cell path loss, the apparatus 20, such as the processor 24, may determine if the operation of the mobile terminal 10 is creating or is likely to have created interference for the neighbor cells 16. In one embodiment, the apparatus may include means, such as the processing circuitry 22, the processor or the like, for determining whether two or more of the various parameters satisfy respective thresholds. See operation 34 of FIG. 3. For example, the apparatus, such as the processor, may be configured to compare the transmission power to a first threshold with the transmission power satisfying the first threshold by exceeding the first threshold, to compare the path loss to a second threshold with the pathloss satisfying the second threshold by being less than the second threshold and/or to compare one or more other parameters, such as the uplink interference level, the serving cell path loss and/or the difference between the transmission power and the serving cell path loss, to respective thresholds. The thresholds may be pre-defined and stored by memory 28 of the apparatus. Alternatively, a network element, such as the serving cell 12, a radio network controller or the like, may notify the mobile terminal of the respective thresholds, such as via an RRC measurement control message or via system information, such as SIBS, SIB11, SIB11bis and/or SIB12.

In one embodiment, the parameters need not just satisfy respective thresholds at one instant in time in order to be considered to be indicative of neighbor cell interference, but must satisfy the respective thresholds for predetermined periods of time, such as for respective times to trigger. The time to trigger may be the same for each parameter or may be different for one or all of the parameters. As such, in one embodiment, the apparatus 20 includes means, such as the processing circuitry 22, the processor 24 or the like, for determining whether the transmission power satisfies a first threshold for a first period of time. In this embodiment, the apparatus, such as the processor, may also or alternatively be configured to determine whether the path loss satisfies a second threshold for a second period of time. And, in one embodiment, the apparatus, such as the processor, may also or alternatively determine whether one or more other parameters, such as the uplink interference level at a neighbor cell 16, the serving cell path loss and/or the difference between the transmission power and the serving cell path loss, satisfies the respective thresholds for the respective periods of time. As with the respective thresholds, the period(s) of time may be predefined and stored by memory 28 of the apparatus or may be provided by the network, such as by the serving cell 12, a radio network controller or the like.

While the apparatus 20, such as the processor 24, may simply continue to monitor the various parameters for an indication of neighbor cell interference without sending a measurement report in an instance in which the parameters do not satisfy the respective thresholds, the apparatus may cause a measurement report to be provided from the mobile terminal 10 to a network element, such as the serving cell 12, a radio network controller or the like, in an instance in which two or more of the parameters do satisfy the respective thresholds, such as for the respective periods of time. Various combinations of the parameters may be utilized to identify instances of potential neighbor cell interference. In this regard, the apparatus may include means, such as the processing circuitry 22, the processor 24, the communication interface 26 or the like, for causing a measurement report to be provided to the network element in an instance in which two or more parameters, such as two or more of the transmission power, the neighbor cell path loss, the uplink interference level, the serving cell path loss, the difference between the transmission power and the serving cell path loss or other parameters, satisfy respective thresholds. See operation 36 of FIG. 3. The measurement report may include an indication of one or more of the various parameters, such as the transmission power, such as the DPCCH transmission power, the path loss from the neighbor cells 16, the uplink interference level, the serving cell path loss, the difference between the transmission power and the serving cell path loss and/or other parameters). With respect to the parameters that are associated with a respective neighbor cell, such as the path loss and/or the uplink interference level, the measurement report may also include an identification of the neighbor cell, such as the cell identity and/or the primary scrambling code (PSC) of the neighbor cell. As described above, while the apparatus relies upon two or more of the parameters to determine the potential for neighbor cell interference, the measurement report need not include each of the parameters, but may include only a subset of the parameters, such as only a single parameter in some embodiments.

The mobile terminal 10 may provide the measurement report to the serving cell 16, a radio network controller or other network element. Upon receipt of the measurement report, the network element may determine if any action is necessary in order to reduce neighbor cell interference. For example, the network element may cause the mobile terminal to transition from a CELL_FACH state to a CELL_DCH state so as to permit the uplink power from the mobile terminal to be controlled by not only the serving cell, but also the neighbor cells 16, thereby reducing neighbor cell interference. Additionally or alternatively, the network element may cause the transmission power of the mobile terminal to be reduced by reducing a serving grant for the mobile terminal or releasing packet switched (PS) domain radio access bearer(s) (RAB)(s) following the measurement report. In this regard, a PS domain RAB may require relatively large amounts of uplink data transmissions such that the release of a PS domain RAB may reduce neighbor cell interference. In any of the foregoing or other embodiments, the measurement report provided by the mobile terminal may enable a network element, such as the serving cell, a radio network controller or the like, to take appropriate measures in order to reduce neighbor cell interference, even in an instance in which the mobile terminal was operating in a state, such as a CELL_FACH state, in which the mobile terminal only received signals from the serving cell and not from the neighbor cells.

As indicated above, the method, apparatus and computer program product of one embodiment are configured to permit a mobile terminal 10 operating in a CELL_FACH to determine the potential for neighbor cell interference and to trigger a measurement report based upon the potential neighbor cell interference even while the mobile terminal is in the CELL_FACH state. In order to provide further explanation of this embodiment, reference is made to FIG. 4 in which the mobile terminal is initially operating in a CELL_FACH state as shown in operation 40. The apparatus 20 of this embodiment may include means, such as the processing circuitry 22, the processor 24 or the like, for determining whether neighbor cell interference is being caused by the mobile terminal while the mobile terminal is in the CELL_FACH state. See operation 42 of FIG. 4. As described above, the apparatus, such as a processor, may determine whether neighbor cell interference is being caused by determining whether one or more parameters satisfy respective thresholds. For example, the apparatus, such as a processor, may determine whether the transmission power for signals transmitted via an uplink channel satisfies a respective threshold, whether a path loss for signals received from the neighbor cell satisfies a respective threshold, whether an uplink interference level at the neighbor cell satisfies a respective threshold, whether the serving cell path loss satisfies a respective threshold and/or whether the difference between the transmission power and the serving cell path loss satisfies a respective threshold. As also described above, the apparatus, such as the processor, may determine whether one or more of these parameters satisfy the respective threshold(s) for at least a predefined period of time.

In an instance in which the apparatus 20, such as the processor 24, does not determine that neighbor cell interference is being created, the apparatus need not issue a measurement report and, instead, the mobile terminal 10 may continue to operate in the CELL_FACH state while the apparatus continues to monitor the various parameters for an indication of neighbor cell interference. However, the apparatus may also include means, such as the processing circuitry 22, the processor, the communication interface 26 or the like, for causing a measurement report to be provided to a network element, such as the serving cell 12, a radio network controller or other network element, in an instance in which it is determined that neighbor cell interference is being caused. Based upon the measurement report including, for example, one or more of the parameters that have been determined and the identity of a neighbor cell 16 in an instance in which a parameter is associated with a respective neighbor cell, the network element may determine if the operation of the mobile terminal is to be modified so as to reduce any neighbor cell interference. In one embodiment, the network element may cause the mobile terminal to transition to a CELL_DCH state so as to permit neighbor cell interference to be reduced. In this embodiment, the apparatus may include means, such as the processing circuitry, the processor, the communication interface or the like, for transitioning to the CELL_DCH state in response to direction from the network element and following provision of the measurement report to the network element. See operation 46 of FIG. 4. As described above, the network element may alternatively make no modifications to the operation of the mobile terminal or may make other types of modifications in order to reduce the neighbor cell interference, such as by reducing the serving grant for the mobile terminal or by releasing PS domain RAB(s) following the measurement report.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. For example, while the apparatus of the embodiment described above causes a measurement report to be triggered in response to two or more parameters satisfying respective thresholds, such as for a predefined period of time, the apparatus of other embodiments may trigger a measurement report in response to a single parameter satisfying a respective threshold or any number of parameters satisfying respective thresholds. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
determining two or more parameters indicative of neighbor cell interference and selected from a group consisting of transmission power for signals transmitted via an uplink channel, a neighbor cell path loss for signals received from a neighbor cell, an uplink interference level, a serving cell path loss and a difference between the transmission power and the serving cell path loss; and
in instance in which the two or more parameters satisfy respective thresholds, causing a measurement report including an indication of at least one of the parameters to be provided to a network element.

2. A method according to claim 1 further comprising determining whether the two or more parameters satisfy the respective thresholds for respective time periods, wherein causing the measurement report to be provided is dependent upon the two or more parameters satisfying the respective thresholds for the respective time periods.

3. A method according to claim 1 wherein causing the measurement report to be provided comprises causing an identification of the neighbor cell to be provided.

4. A method according to claim 1 further comprising determining the two or more parameters and causing the measurement report to be provided while in a CELL_FACH state.

5. An apparatus comprising:
at least one processor; and
at least one memory including computer program code, the at least one memory and the computer program code configured to, with the at least one processor, cause the apparatus at least to:
determine two or more parameters indicative of neighbor cell interference and selected from a group consisting of transmission power for signals transmitted via an uplink channel, a neighbor cell path loss for signals received from a neighbor cell, an uplink interference level, a serving cell path loss and a difference between the transmission power and the serving cell path loss; and
in instance in which two or more parameters satisfy respective thresholds, cause a measurement report including an indication of at least one of the parameters to be provided to a network element.

6. An apparatus according to claim 5 wherein the at least one memory and the computer program code are further configured to, with the at least one processor, cause the apparatus to determine whether the two or more parameters satisfy the respective thresholds for respective time periods, and wherein the at least one memory and the computer program code are configured to, with the at least one processor, cause the apparatus to cause the measurement report to be provided dependent upon the two or more parameters satisfying the respective thresholds for the respective time periods.

7. An apparatus according to claim 5 wherein the at least one memory and the computer program code are further configured to, with the at least one processor, cause the apparatus to cause an identification of the neighbor cell to be provided with the measurement report.

8. An apparatus according to claim 5 wherein the at least one memory and the computer program code are configured to, with the at least one processor, cause the apparatus to determine the two or more parameters and cause the measurement report to be provided while in a CELL_FACH state.

9. An apparatus according to claim 5 wherein the apparatus comprises a mobile terminal and further comprises a user interface configured to receive user input.

10. An apparatus according to claim 5 wherein the apparatus is configured to operate in accordance with the Long Term Evolution (LTE) specification.

11. A method comprising:
while in a CELL_FACH state, determining whether neighbor cell interference is being caused; and
in instance in which neighbor cell interference is being caused, causing a measurement report to be provided to a network element.

12. A method according to claim 11 further comprising transitioning to a CELL_DCH state in response to direction from the network element following provision of the measurement report to the network element.

13. A method according to claim 11 wherein determining whether neighbor cell interference is being caused comprises determining whether transmission power for signals transmitted via an uplink channel satisfies a respective threshold.

14. A method according to claim 11 wherein determining whether neighbor cell interference is being caused comprises determining whether a neighbor cell path loss for signals received from a neighbor cell satisfies a respective threshold.

15. A method according to claim 11 wherein determining whether neighbor cell interference is being caused comprises determining whether an uplink interference level at the neighbor cell satisfies a respective threshold.

16. A method according to claim 11 wherein determining whether neighbor cell interference is being caused comprises determining whether a serving cell path loss satisfies a respective threshold.

17. A method according to claim 11 wherein determining whether neighbor cell interference is being caused comprises determining whether a difference between transmission power for signals transmitted via an uplink channel and a serving cell path loss satisfies a respective threshold.

18. A method according to claim 11 wherein causing the measurement report to be provided comprises causing an identification of a neighbor cell with which interference is being created to be provided.

19. A method according to claim 11 wherein determining whether neighbor cell interference is being caused comprises determining whether two or more parameters indicative of neighbor cell interference satisfy respective thresholds, and wherein causing the measurement report to be provided comprises causing an indication of at least one of the parameters to be provided with the measurement report.
